(19) United States
(12) Patent Application Publication
(10) Pub. No.: US 2025/0128470 A1
(43) Pub. Date: Apr. 24, 2025

(54) 3D PRINTING METHODS

(71) Applicant: Hewlett-Packard Development Company, L.P., Spring, TX (US)

(72) Inventors: Emre Hiro Discekici, San Diego, CA (US); Jake Henry Thomas, San Diego, CA (US); Emily Levin, San Diego, CA (US)

(21) Appl. No.: 18/834,540

(22) PCT Filed: Feb. 8, 2022
(86) PCT No.: PCT/US2022/015559

§ 371 Date: Jul. 30, 2024

(51) Int. Cl. B29C 64/165; B29K 105/00; B33Y 10/00; B33Y 70/00

(52) U.S. Cl. CPC B29C 64/165; B33Y 10/00; B33Y 70/00; B29K 2105/0038; B29K 2105/005; B29K 2105/0073

(57) ABSTRACT

This disclosure describes a method of printing a 3D printed object. The method comprises: selectively applying a fusing agent onto a portion of a build material, wherein the fusing agent comprises a radiation-absorbing dye dissolved in an aqueous liquid carrier; exposing the selectively applied fusing agent to radiation to produce heat energy to fuse the portion of build material to form a layer of the 3D printed object; and thermally treating the 3D printed object at a temperature of above 70° C.

### BACKGROUND

Three-dimensional (3D) printing may be an additive printing process used to make three-dimensional solid parts from a digital model. 3D printing can be used in rapid product prototyping, mold generation, mold master generation, and short run manufacturing. Some 3D printing techniques are considered additive processes because they involve the application of successive layers of material. This is unlike customary machining processes, which rely upon the removal of material to create the final part. In 3D printing, build material may be fused, for example, by heat-assisted extrusion, melting or sintering.

### BRIEF DESCRIPTION OF THE DRAWINGS

FIG. 1A-1E depict an example 3D printing method

FIG. 2 are microtome images of example 3D printed objects printed according to Example 2 and Comparative Example A before and after thermal treatment; and

FIG. 3 illustrates strain at break (%) measurements of example 3D printed objects printed according to Example 2 in each of the xy, yx and z orientations.

### DETAILED DESCRIPTION

In some 3D printing methods, a fusing agent comprising a radiation absorber may be selectively applied to a build material. When the selectively applied fusing agent is exposed to electromagnetic radiation, the radiation absorber may absorb the electromagnetic radiation and convert it to thermal energy. This thermal energy can fuse or coalesce the build material to form a layer of the 3D printed object. A subsequent layer of build material may be applied to the newly formed layer and the process may be repeated to build the 3D printed object layer-by-layer.

In some instances, the 3D printing method can introduce anisotropy into the resulting 3D printed object. For example, it has been found that the sequence of fusing agent and build material deposition can lead to spatial variations in radiation absorber concentration in the build direction. This can result in the 3D printed object having anisotropic mechanical properties. For example, the 3D printed object may have mechanical properties in the direction of build that are significantly different to mechanical properties observed in, for example, directions perpendicular to the direction of build.

By selecting particular radiation absorbers and thermally treating the fused build material, it has been found that it is possible to improve the isotropy of the 3D printed object. For example, by selecting particular radiation absorbers and thermally treating the fused build material, the mechanical properties of the 3D printed object in directions parallel to the build direction can become closer to the mechanical properties of the object in directions perpendicular to the build direction.

According to a first aspect of the present disclosure, there is provided a method of printing a 3D printed object. The method comprises selectively applying a fusing agent onto a portion of a build material. The fusing agent comprises a radiation-absorbing dye dissolved in an aqueous liquid carrier. The selectively applied fusing agent is exposed to radiation to produce heat energy to fuse the portion of build material to form a layer of the 3D printed object. The 3D printed object is thermally treated at a temperature of above about 70° C.

According to a further aspect, there is provided a 3D printed object obtainable by the method of the first aspect of the present disclosure.

In the present disclosure, the radiation absorber is a radiation-absorbing dye that is dissolved in an aqueous carrier. Because the dye is dissolved in the aqueous carrier, this can facilitate migration of the dye through the 3D printed object during post-printing thermal treatment. Without wishing to be bound by theory, thermally treating the fused build material layers in the 3D printed object can also soften the build material and/or promote migration of the dye in the object's structure. This can improve isotropy, as localization of radiation absorber at selected regions within the structure may be reduced. In some examples, prior to thermal treatment, the 3D printed object comprises a first region and a second region, wherein the concentration of radiation-absorbing dye in the first region is higher than the concentration of radiation-absorbing dye in the second region. During thermal treatment, migration of radiation-absorbing dye occurs between the first region and the second region to decrease the difference in concentration in radiation-absorbing dye between the first region and the second region.

In some examples, the 3D printed object may comprise a structure comprising first regions and second regions. The first regions may have higher concentrations of radiation-absorbing dye and the second regions may have lower concentrations of radiation-absorbing dye. During thermal treatment, migration of radiation-absorbing dye can occur between the first and second region(s). This migration can decrease the localization of radiation-absorbing dye within the 3D printed object. Accordingly, this can increase the isotropy in the structure of the 3D printed object.

The first and second region(s) may arise in the 3D printed object as a result of the sequence in which the build material and fusing agent are deposited during the build process. For example, where the fusing agent is applied to a layer of build material, the radiation-absorbing dye may be localized at or adjacent to the sites of application of the fusing agent. As the 3D printed object is built in a layer-by-layer process, the fused build material may comprise a structure comprising alternating first regions and second regions in the build direction. Accordingly, in some examples, there may be an alternating concentration of radiation-absorbing dye within the structure of the 3D printed object, whereby first regions of high concentration of radiation-absorbing dye alternate with second regions of low concentration of radiation-absorbing dye. Prior to thermal treatment, the 3D printed object may have anisotropic properties, whereby certain mechanical properties (e.g. elongation at break) in the build direction may be e.g. different from the corresponding properties in a direction perpendicular to the build direction. During thermal treatment, migration of radiation-absorbing dye can occur between the first and second regions to increase the isotropy in the structure of the fused build material. The resulting 3D printed object may have improved isotropic properties. For example, after thermal treatment, the elongation at break along the build direction may be at least 60% of the elongation at break perpendicular to the build direction. In some instances, the elongation at break perpendicular to the layers of the 3D printed object (i.e. in the build direction) is less than 60%, less than 50% or less than 45% of the elongation at break along the layers of the 3D printed object (i.e. perpendicular to the build direction). After thermal treatment, the elongation at break along the build direction may be 60 to 100%, for example, 70 to 100% of the elongation at break perpendicular to the build direction.

In some examples, e.g. prior to thermal treatment, a further layer of build material may be applied to the layer of the 3D printed object, and further fusing agent selectively applied to a portion(s) of the newly applied layer of build material. The fusing agent may then be exposed to electromagnetic radiation to produce heat energy to fuse the portion(s) of build material to form a further layer of the 3D printed object. Layers of build material may be repeatedly applied and fused to build the 3D printed object in a layer-by-layer process. The 3D printed object may be heated at a temperature of above about 70° C. to thermally treat the 3D printed object. Thermal treatment may be performed e.g. in a separate heating chamber or within the printer.

Thermal treatment may be carried out by thermally treating the 3D printed object in any suitable environment. For example, thermal treatment may be carried out in air, an inert environment and/or vacuum environment. To provide an inert environment, the concentration of e.g. oxygen in air may be reduced. Alternatively, thermal treatment in an inert environment may carried out by thermally treating the 3D printed object in nitrogen or other inert gas.

As mentioned above, the 3D printed object may be thermally treated at a temperature of above about 70° C. In some examples, the 3D printed object may be thermally treated at a temperature at least about 80° C., at least about 90° C., at least about 100° C., at least about 110° C., at least about 120° C., at least about 130° C., at least about 140° C., or at least about 150° C. The temperature for thermal treatment may be selected to be suitable for softening the build material and/or promote migration of the radiation-absorbing dye. However, the temperature can be lower than the melting temperature of the build material to ensure that the 3D printed object maintains its desired shape. In some examples, thermal treatment may be carried out at a temperature of above about 70° C. up to the melting temperature of the build material.

The 3D printed object may be thermally treated at a temperature below the melting temperature of the build material. In some examples, the 3D printed object may be thermally treated at a temperature that is within 100° C. below the melting temperature of the build material. In some examples, the 3D printed object may be thermally treated at a temperature that is within 90° C., within 80° C., within 70° C., within 60° C. or within 50° C. below the melting temperature of the build material. In some examples, the 3D printed object may be thermally treated at a temperature that is more than about 5° C. more than about 10° C., more than about 15° C., more than about 20° C. or more than about 25° C. below the melting temperature of the build material. In some examples, the 3D printed object may be thermally treated at a temperature that is 5 to 90° C., 10 to 80° C., 15 to 70° C., 20 to 60° C. or 25 to 50° C. below the melting temperature of the build material.

The duration of thermal treatment may be varied to control the degree of migration of the radiation-absorbing dye. As discussed above, the radiation-absorbing dye is applied to successive layers of build material. Prior to thermal treatment, the radiation-absorbing dye may concentrate in regions e.g. at or in the vicinity of the interface between the successively fused layers. The duration of thermal treatment may be varied e.g. together with the temperature of treatment to promote migration of the radiation-absorbing dye further away from the interface to improve distribution of the dye through the structure. In some examples, thermal treatment may be performed for a duration of 10 minutes to 24 hours, for example, 30 minutes to 10 hours or 1 to 6 hours. The precise duration can vary depending on the selected temperature. Higher temperatures may allow for lower durations of treatment, while lower temperatures may require longer durations of treatment.

In some examples, the build material may comprise a polymer. Suitable polymers are described in further detail below. The build material may be a polymer having a melting temperature of at least about 140° C., at least about 150° C., at least about 160° C., at least about 170° C., at least about 180° C., at least about 190° C. The build material may be a polymer having a melting temperature of less than about 300° C., less than about 290° C., less than about 280° C., less than about 270° C., less than about 260° C., less than about 250° C. or less than about 240° C. In some examples, the build material may be a polymer having a melting temperature in the range of 140 to 300° C., 150 to 280° C. 160 to 260° C., 170 to 270° C., 180 to 260° C. or 190 to 250 $C.

The build material may melt at a discrete temperature or may melt over a range of temperatures. For example, the build material may melt of a range that spans a 15, 10 or 5° C. range. Where the build material may melt over a range of temperatures, the build material may be thermally treated at a temperature below e.g. the lower limit of the melting range. For example, the 3D printed object may be thermally treated at a temperature that is within 100° C., 90° C., within 80° C., within 70° C., within 60° C. or within 50° C. below the lower limit of the melting range. In some examples, the 3D printed object may be thermally treated at a temperature that is more than about 5° C., more than about 10° C. more than about 15° C., more than about 20° C. or more than about 25° C. below lower limit of the melting range. In some examples, the 3D printed object may be thermally treated at a temperature that is 5 to 90° C., 10 to 80° C., 15 to 70° C., 20 to 60° C. or 25 to 50° C. below the lower limit of the melting range.

The fusing agent comprises a radiation-absorbing dye dissolved in an aqueous carrier. Suitable radiation-absorbing dyes are described below. In some examples, the radiation-absorbing dye absorbs radiation in the infrared (e.g. near infrared) or visible region of the electromagnetic spectrum.

When fusing agents comprising radiation-absorbing dyes dissolved in aqueous carriers are employed, the radiation-absorbing dye can migrate through the fused build material, reducing the risk of anisotropy in the resulting 3D object. It has been found that certain radiation absorbers may be more likely to result in product anisotropy because they have an increased tendency to remain localized at or near their region of application, even after thermal treatment. For example, radiation-absorbing pigments that are dispersed rather than dissolved in the liquid carrier of the fusing agent may remain at or near their site of application and be more resistant to migration even after thermal treatment. In examples of the present disclosure, the concentration of radiation-absorbing pigments in the fusing agent may be reduced. For example, the fusing agent may comprise less than 1.5 weight %, less than 1 weight % or less than 0.5 weight % of a radiation-absorbing pigment. In some examples, the fusing agent may comprise less than 0.4, less than 0.3, less than 0.2, less than 0.1 weight % of radiation-absorbing pigment. In some examples, the fusing agent may comprise no radiation-absorbing pigment.

The fusing agent comprises an aqueous liquid carrier. The aqueous liquid carrier may comprise water and an organic solvent. The organic solvent may be miscible in water. In some examples, the organic solvent comprises a first organic solvent and a second organic solvent. The first organic solvent may be a plasticizing solvent. The second organic solvent may be a solubilizer for solubilizing the plasticizing solvent and/or the radiation-absorbing dye in the liquid aqueous carrier. Examples of the first organic solvent may be selected from benzyl alcohol and diethylene glycol butyl ether (DEGBE). Examples of the second organic solvent may be selected from diethylene glycol butyl ether (DEGBE), 1,2-hexanediol, hydroxyethyl-2-pyrrolidone (HE2P), glycerol, propylene glycol, ethylene glycol and 1,5-pentane diol. The weight ratio of the first organic solvent to the second organic solvent may be 1:8 to 1:1, for example, 1:2 to 1:4.

In some examples, the fusing agent may also include additives e.g. urea.

### Build Material

The build material may comprise a polymeric or polymeric composite build material. As used herein, the term “polymeric build material” may refer to crystalline or semi-crystalline polymer. As used herein, the term “polymeric composite build material” may refer to composite material made up of polymer and ceramic.

Examples of semi-crystalline polymers include semi-crystalline thermoplastic materials with a wide processing window of greater than 5° C. (i.e., the temperature range between the melting point and the re-crystallization temperature). Some specific examples of the semi-crystalline thermoplastic materials include polyamides (PAS) (e.g., PA 11/nylon 11, PA 12/nylon 12, PA 6/nylon 6, PA 8/nylon 8, PA 9/nylon 9, PA 66/nylon 66, PA 612/nylon 612, PA 812/nylon 812, PA 912/nylon 912, etc.). Other examples of crystalline or semi-crystalline polymers suitable for use as the polymeric build material include modified polyamides, polyethylene, polypropylene, and polyoxomethylene (i.e., polyacetals), polyethylene terephthalate (PET), while amorphous variations of these materials may also be used as alternative build materials. Still other examples of suitable polymeric build materials include polystyrene, polycarbonate, polyester, polyurethanes, other engineering plastics, and blends or copolymers of any two or more of the polymers listed herein. Core shell polymer particles of these materials may also be used.

Polymeric build material, for example, any of the previously listed crystalline or semi-crystalline polymers may be combined with ceramic material to form the polymeric composite build material. Examples of suitable ceramic material include metal oxides, inorganic glasses, carbides, nitrides and borides. Some specific examples include alumina (Al2O3), zinc oxide (ZnO), glass, silicon mononitride (SiN), silicon dioxide (SiO2), zirconia (ZrO2), titanium dioxide (TiO2), or combinations thereof. The amount of ceramic material that may be combined with the crystalline or semi-crystalline polymer may depend on the materials used and the 3D part to be formed. In one example, the ceramic material may be present in an amount ranging from about 1 wt % to about 40 wt % based on the total weight of the polymeric composite build material.

The build material may be a powder bed material. The build material may be made up of similarly sized particles or differently sized particles. In an example, the average size of the particles of the build material in the build material ranges from about 2 micrometer (μm) to about 200 μm. In another example, the average particle size of the polymeric or polymeric composite build material ranges from about 20 μm to about 90 μm, or about 40 μm to about 50 μm. In still another example, the average particle size of the polymeric or polymeric composite build material is about 60 μm. Size, as used herein, refers to the diameter of a spherical particle, or the average diameter of a non-spherical particle (i.e., the average of multiple diameters across the particle), or the volume-weighted mean diameter of a particle distribution. In some examples, the average particle size may be a volume-weighted mean diameter of a particle distribution determined using laser diffraction or laser scattering (e.g., with a Malvern Mastersizer S, version 2.18).

In some examples, the build material may include whitener. The whitener may include ZnO2 or TiO2, among other whitener fillers.

The build material may further include other components such as an antioxidant, a charging agent, a flow aid or a combination thereof. While several examples of these components are provided, it is to be understood that these components are selected to be thermally stable (i.e., will not decompose) at the 3D printing temperatures.

Antioxidant(s) may be added to the build material to prevent or slow molecular weight decreases of the polymeric or polymeric composite build material and/or may prevent or slow discoloration (e.g., yellowing) of the polymeric or polymeric composite build material. In some examples, the antioxidant may include IRGANOX® 1098 (benzenepropanamide, N,N′-1,6-hexanediylbis(3,5-bis(1,1-dimethylethyl)-4-hydroxy)), IRGANOX® 254 (a mixture of 40% triethylene glycol bis(3-tert-butyl-4hydroxy-5-methylphenyl), polyvinyl alcohol and deionized water), and/or other sterically hindered phenols. In other examples, the antioxidant may include a phosphite and/or an organic sulfide (e.g., a thioester). In an example, the antioxidant may be included in the build material in an amount ranging from about 0.01 wt % to about 5 wt %, based on the total weight of the build material.

Charging agent(s) may be added to suppress tribo-charging. Example charging agents include aliphatic amines (which may be ethoxylated), aliphatic amides, quaternary ammonium salts (e.g., behentrimonium chloride or cocamidopropyl betaine), esters of phosphoric acid, polyethylene glycol esters, or polyols. Some commercially available charging agents include HOSTASTAT® FA 38 (natural based ethoxylated alkylamine), HOSTASTAT® FE2 (fatty acid ester), and HOSTASTAT® HS 1 (alkane sulfonate), available from Clariant Int. Ltd.). In some examples, the charging agent is added in an amount ranging from greater than 0 wt % to less than 5 wt % of the total weight of the build material.

Flow aid(s) may be added to improve the coating flowability of the build polymeric composite build material has an average particle size less than 25 μm. The flow aid may improve the flowability of the build material by reducing the friction, the lateral drag, and the tribocharge buildup (by increasing the particle conductivity).

Examples flow aids include tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), or polydimethylsiloxane (E900). In some examples, the flow aid is added in an amount ranging from greater than 0 wt % to less than 5 wt % based upon the total weight of the build material.

### Fusing Agent

As described above, the fusing agent comprises a radiation-absorbing dye. The radiation-absorbing dye may absorb electromagnetic light in the visible region, or infra-red (including near infra-red) region. The dyes may be of any colour, for example, cyan, magenta, yellow, red, blue, and black, among others. Examples of radiation-absorbing dyes include Direct Black (DB) 168, Acid Yellow (AY) 23, AY 17, Acid Red (AR) 52, AR 289, Reactive Red 180 (RR 180), and Direct Blue (DB) 199.

The radiation-absorbing dye may absorb radiation at the wavelength range between about 380 nanometers (nm) and about 780 nm. In some examples, the radiation-absorbing dye absorbs radiation at a wavelength of greater than about 380 nm and less than about 700 nm, such as less than 650 nm, less than 600 nm, less than 590 nm, less than 580 nm, less than 550 nm, less than 500 nm, less than 450 nm, and less than 400 nm. The radiation-absorbing dye may reflect radiation at wavelengths of about 750 nm. 590 nm, 580 nm, 550 nm, 500 nm, 455 nm, 450 nm, or 380 nm, and may absorb other e.g. visible light wavelengths. The radiation-absorbing dye may absorb at the wavelength range that includes and/or overlaps with a wavelength range of a light source (e.g., fusing lamp) used to fuse the build material.

In some examples, the radiation-absorbing dye may be present in the fusing agent in an amount of less than 5 weight %, for example, less than 4 weight % or less than 3 weight %. In some examples, the radiation-absorbing dye may be present in an amount of less than 2 weight %. Suitable amounts range from about 0.01 wt % to about 5 wt %, from 0.02 wt % to 4.5 wt %, from 0.03 wt % to 4 wt. %. In some examples, the amount of radiation-absorbing dye may be from about 0.5 wt % to about 5 wt %, from about 0.7 wt % to about 4.5 wt %, or from about 0.7 wt % to about 3.5 wt % of the total weight of the fusing agent.

The fusing agent comprises a radiation-absorbing dye dispersed in an aqueous carrier. The aqueous nature and particular components of the fusing agent may enhance the wetting properties of the fusing agent. This may allow for the radiation absorber within the fusing agent to be spread uniformly over the build material surface.

The fusing agent may further comprise co-solvent(s) in addition to water. The co-solvent(s) may be organic solvent(s). The co-solvent(s) may allow for the radiation absorber to spread over the build material, when applied thereto, and/or penetrate into a layer of the build material. The co-solvents may have a boiling point of greater than about 120° C. and/or provide vapor pressure that is sufficiently low to prevent flammability.

Classes of organic co-solvents that may be used in a water-based fusing agent include aliphatic alcohols, aromatic alcohols, diols, glycol ethers, polyglycol ethers, 2-pyrrolidones, caprolactams, formamides, acetamides, glycols, and long chain alcohols. Examples of these cosolvents include primary aliphatic alcohols, secondary aliphatic alcohols, 1,2-alcohols, 1,3-alcohols, 1,5-alcohols, 1,6-hexanediol or other diols (e.g., 1,5-pentanediol, 2-methyl1,3-propanediol, etc.), ethylene glycol alkyl ethers, propylene glycol alkyl ethers, higher homologs (C6-C12) of polyethylene glycol alkyl ethers, triethylene glycol, tetraethylene glycol, tripropylene glycol methyl ether, N-alkyl caprolactams, unsubstituted caprolactams, both substituted and unsubstituted formamides, both substituted and unsubstituted acetamides, and the like. Other examples of organic co-solvents include dimethyl sulfoxide (DMSO), isopropyl alcohol, ethanol, pentanol, acetone, or the like.

In some examples, the fusing agent comprises an organic solvent in addition to water. In some examples, the organic solvent comprises a first organic solvent and a second organic solvent.

The first organic solvent may provide a reduction in a melting point of a build material when the fusing agent comes in contact therewith. For example, the first organic solvent may have plasticizing characteristics when interacting with the build material. In some examples, the first co-solvent includes poly(trimethylene glycol), benzyl alcohol or diethylene glycol butyl ether, among other organic co-solvents.

The second organic solvent may provide miscibility to the plasticizing first organic solvent. For example, the second co-solvent may provide miscibility for the first co-solvent with water. The second organic solvent may also act as a solubilizer for the radiation-absorbing dye.

Examples of the second co-solvent include 2-hydroxyethyl pyrrolidone (HE2P), 1,5-pentanediol, 1,2-hexanediol, 2-pyrrolidinonetriethylene glycol, tetraethylene glycol, 2-methyl-1,3-propanediol, 1,6-hexanediol, diethylene glycol butyl ether, 1,2-propanediol, tripropylene glycol methyl ether, glycerol, ethylene glycol, propylene glycol, butylene glycol, pentylene glycol, hexylene glycol, ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, propylene glycol methyl ether, diethylene glycol monomethyl ether, diethylene glycol monoethyl ether, diethylene glycol mono-n-butyl ether, dipropyleneglycol methyl ether, ethylene glycol dimethyl ether, ethylene glycol diethyl ether, ethylene glycol dibutyl ether, among other organic co-solvents.

In some examples, the first organic solvent is present in an amount ranging from about 10 wt % to about 35 wt % of the total weight of the fusing agent and the second organic solvent is present in an amount ranging from about 10 wt % to about 65 wt % of the total weight of the fusing agent. In some examples, the first organic solvent is present in an amount ranging from about 15 wt % to about 35 wt %, about 20 wt % to about 35 wt %, about 25 wt % to about 35 wt %, about 30 wt % to about 35 wt %, about 10 wt % to about 30 wt %, about 10 wt % to about 20 wt %, and about 12.5 wt % to about 17.5 wt %.

In some examples, the second organic solvent present in an amount ranging from about 15 wt % to about 65 wt %, about 20 wt % to about 60 wt %, about 25 wt % to about 55 wt %, about 30 wt % to about 50 wt %, or about 40 wt % to about 50 wt %.

In some examples, the first and second organic solvents may be present in a combined amount ranging from about 30 wt % to about 80 wt %, about 35 wt % to about 80 wt %, about 40 wt % to about 80 wt %, about 50 wt % to about 80 wt % of the total weight of the fusing agent.

The weight ratio of the first organic solvent to the second organic solvent may be 1:8 to 1:1, for example, 1:2 to 1:4.

In some examples, e.g. where first and organic solvents are present, the fusing agent may also include a humectant. This humectant may improve the mechanical properties of the 3D printed object. An example of a humectant may be urea. Humectant may also aid jetting performance.

In some examples, after fusing, some residual organic solvent (e.g. the first solvent and/or the second solvent) may remain in the object. This residual solvent can facilitate migration of the radiation-absorbing dye during thermal treatment. In some examples, the amount of fusing agent applied may be controlled to control the amount of residual solvent (e.g. the first solvent and/or the second solvent). In some examples, additional solvent may be applied (e.g. the first solvent and/or the second solvent).

In various examples, the fusing agent may further include a surfactant. The surfactant may improve jettability of the fusing agent and/or allow for the fusing agent to spread uniformly and penetrate into a build material layer when applied. In some examples, the surfactant may be present in an amount ranging from about 0.01 wt % to about 1.0 wt % of the total weight of the fusing agent. Non-limiting example surfactants include a secondary alcohol ethoxylate, such as Tergitol™ 15-S-9, Tego Wet 510, or other water-soluble non-ionic surfactants.

The fusing agent may further include other component(s). The other component(s) may include an additive such as a buffer and/or a biocide. In some examples, the total amount of biocide(s) in the fusing agent ranges from about 0 wt % to about 0.95 wt %. Example biocides include NUOSEPT® (Ashland Inc.), UCARCIDE™ and KORDEK™ and ROCIMA™ (Dow Chemical Co.), PROXEL® (Arch Chemicals) series, ACTICIDER B20 and ACTICIDER M20 and ACTICIDE® MBL (blends of 2-methyl-4-isothiazolin-3-one (MIT), 1,2-benzisothiazolin-3-one (BIT), and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.).

The fusing agent may allow for the radiation-absorbing dye of the fusing agent to spread over the build material, when applied thereto, and/or penetrate into a layer of the build material. The first organic solvent of the fusing agent may plasticize (e.g., has plasticizing characteristics) the build material when in contact therewith, such that the build material may fuse using the fusing agent, even at low radiation-absorbing dye concentrations. The radiation-absorbing dye and the first organic solvent may be maintained in solution, for example, by the use of the second organic solvent. By maintaining the radiation-absorbing dye dissolved in the aqueous carrier, migration of the radiation-absorbing dye through the fused build material may be improved, for example, during thermal treatment. The first organic solvent may also plasticize the build material to facilitate migration of the dye and improve the isotropy of the resulting object.

### 3D Printing

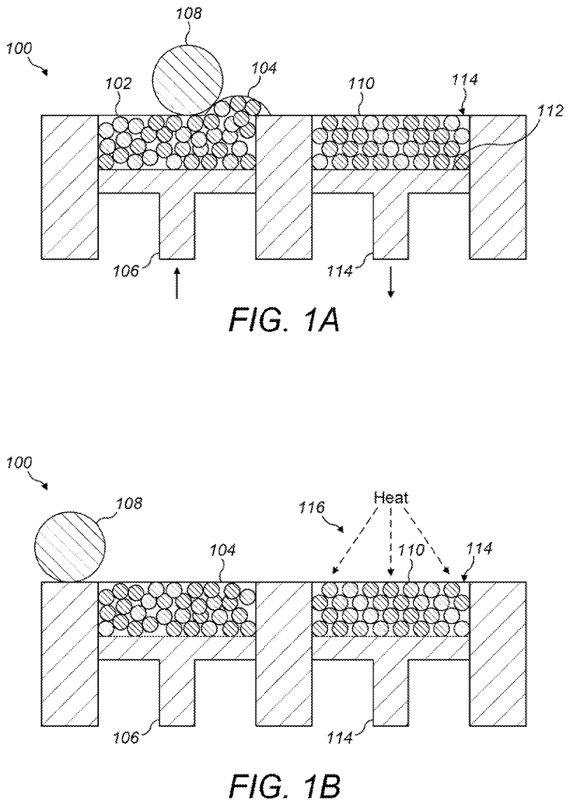

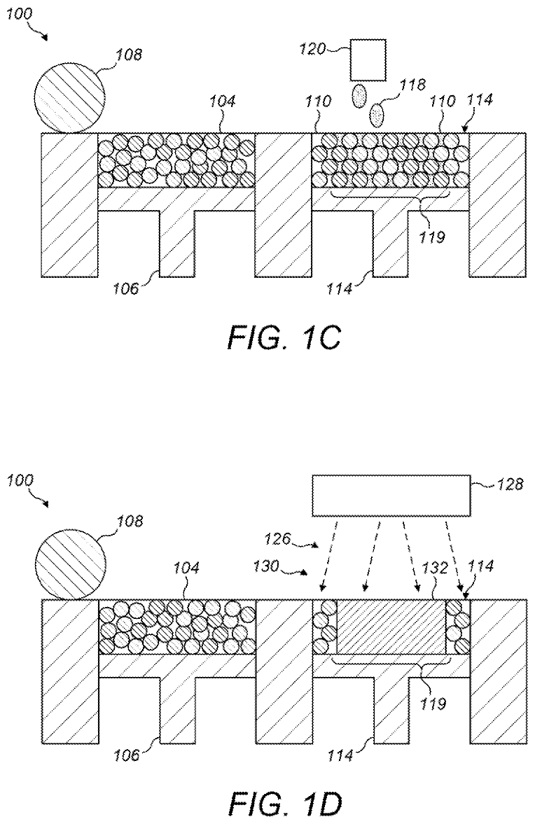

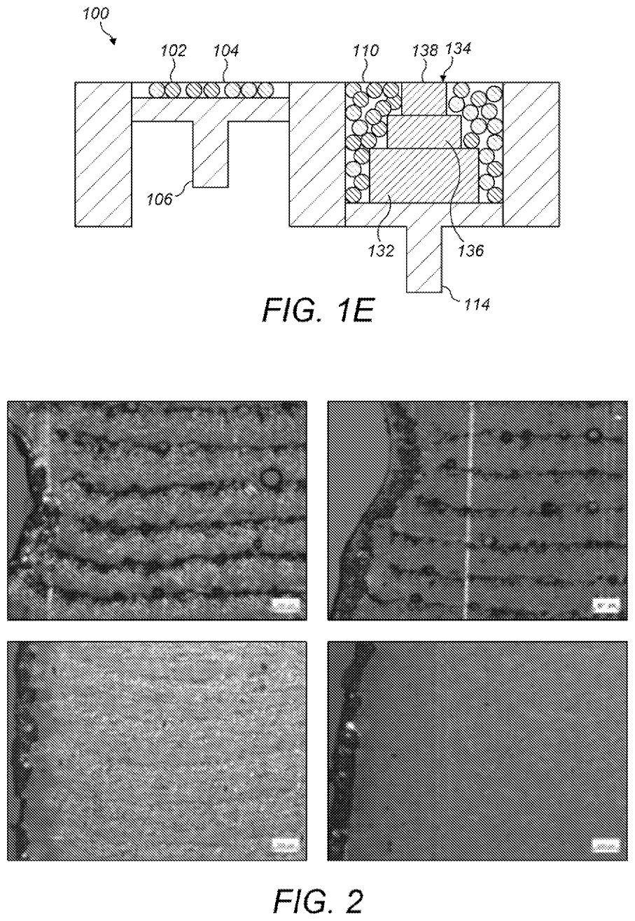

FIGS. 1A-1E illustrate, by way of example, a cross-sectional view of an example 3D printing system for forming a 3D object. The 3D printing system 100 can include a supply bed 102 (including a supply of the build material 104), a delivery piston 106, a roller 108, a fabrication bed 110 (having a contact surface 112), and a fabrication piston 114. The components may be operatively connected to processor circuitry, such as a central processing unit (CPU) (not shown) of the printing system 100. The processor circuitry (e.g., running computer readable instructions stored on a non-transitory, tangible computer readable storage medium) can manipulate and transform data to control the components and to create a part of the 3D object. The data for the selective delivery of the build material and the fusing agent may be derived from a model of the 3D object.

The delivery piston 106 and the fabrication piston 114 may be the same type of piston, and can be programmed to move in opposite directions. In some examples, to form a first layer of the 3D object, the delivery piston 106 may be programmed to push a predetermined amount of the build material 104 out of an opening in the supply bed 102, and the fabrication piston 114 may be programmed to move in the opposite direction of the delivery piston 106 to increase the depth of the fabrication bed. The delivery piston 106 may advance enough so that, when the roller 108 pushes the build material 104 into the fabrication bed 110 and onto the contact surface 112, the depth of the fabrication bed 110 is sufficient so that a layer 114 of the build material 104 may be formed in the bed 110. The roller 108 may be capable of spreading the build material 104 into the fabrication bed 110 to form the layer 114, which is relatively uniform in thickness.

In some examples, the roller 108 may be replaced by other tools, such as a blade for spreading different types of powders, or a combination of a roller and a blade. In some examples, the printing system 100 may not include a supply bed 102 and may include other delivery systems to supply the build material 104 to the fabrication bed 110, such as a trough, a hopper, an auger conveyer, among others. For example, the printing system 100 may include a trough with the supply of the build material 104 which the roller 108 (or other spreader) may push the build material 104 from and into the fabrication bed 110.

After the layer 114 of the build material 104 is introduced into the fabrication bed 110, the layer 114 may be exposed to heating, as shown at 116 of FIG. 1B. Heating may performed to pre-heat the build material 104, such as to a pre-heating temperature below the melting point of the build material 104. As such, the pre-heating temperature selected can depend upon the build material that is used. As examples, the pre-heating temperature may be from about 5° C. to about 30° C. below the melting point of the build material 104. In some examples, the build material 104 is pre-heated to a temperature ranging from about 50° C. to about 430° C., about 50° C. to about 400° C. 50° C. to about 350° C., about 50° C. to about 300° C. about 50° C. to about 250° C. about 50° C. to about 200° C., about 50° C. to about 150° C., about 50° C. to about 100° C., about 100° C. to about 430° C., about 150° C. to about 430° C., about 200° C. to about 430° C., about 250° C. to about 430° C., about 300° C. to about 430° C., or about 350° C. to about 430° C., among other ranges.

In examples where pre-heating is performed, the build material 104 in the layer 114 may be pre-heated using a heat source that exposes the build material 104 in the fabrication bed 110 to the heat. Example heat sources include an electromagnetic radiation source, such as an IR or near-IR light source.

Fusing agent 118 is selectively applied on a portion 119 of the build material 104 in the layer 114, as shown by FIG. 1C. Where a pre-heating stage is used, fusing agent may be applied to the pre-heated build material 104 in layer 114. The fusing agent 118 may be dispensed from an inkjet applicator 120 (e.g., a thermal inkjet or a piezoelectric inkjet printhead). While a single inkjet applicator 120 is shown in FIG. 1C, multiple inkjet applicators may be used that span the width of the fabrication bed 110. The inkjet applicator(s) 120 may be attached to a moving XY stage or a translational carriage (not shown) that moves the inkjet applicator(s) 120 adjacent to the fabrication bed 110 to deposit the fusing agent 118 to target portion(s) (e.g., portion 119) of the layer 114.

The inkjet applicator(s) 120 may be programmed to receive commands from processor circuitry and to deposit the fusing agent 118 according to a pattern of a cross-section for the layer of part of (or the whole of) the 3D object to be formed. The cross-section of the layer of the part of or of the 3D object to be formed can include or refers to the cross-section that is parallel to the contact surface 112 as illustrated by FIG. 1A. The inkjet applicator(s) 120 can selectively apply the fusing agent 118 on portions of the layer 114 that are to be fused to become a layer of the 3D object.

The layer 114 of the build material 104 and the fusing agent 118 may then be exposed to radiation 126 as shown by FIG. 1D. In some examples, the radiation 126 may be within the visible light spectrum. For example, a light source 128 that emits visible light, herein referred to as a visible light-light source, may be used. The light source 128 may include visible light LEDs, lamps, among other light sources. The light source 128 may be attached to a carriage that also holds the inkjet applicator(s) 120. The carriage may move the light source 128 into a position that is adjacent to the fabrication bed 110. The light source 128 may be programmed to receive commands from processor circuitry and to expose the layer 114 and applied fusing agent 118 to the radiation 126 (e.g., visible light energy).

The length of time the radiation 126 is applied for, or the energy exposure time, may be dependent on characteristics of the light source 128, characteristics of the build material 104, and/or characteristics of the fusing agent 118.

The radiation-absorbing dye in the fusing agent 118 can convert the absorbed radiation to thermal energy. This thermal energy (e.g., heat) may be transferred to the build material 104 in contact with the fusing agent. The fusing agent 118 may elevate the temperature of the build material 104 in the portions(s) 119 near or above its melting point, allowing fusing (which may include melting, sintering, binding) of the build material to take place.

In some examples, the fusing agent 118 may cause heating of the build material 104 to below its melting point but to a temperature suitable to cause softening and bonding. The portion(s) not having the fusing agent 118 applied thereto, such as the portion 130, absorb less energy, and the build material 104 within these portion(s) 130 do not fuse. This forms one layer 132 of a part of the 3D object 134 (FIG. 1D) to be formed.

The above may be repeated to create subsequent layers 136, 138 as illustrated by FIG. 1E and to form the 3D object 134. Heat absorbed by a portion of the build material 104 on which fusing agent 118 is applied to or has penetrated may propagate to a previously solidified layer, such as layer 132, causing at least some of that layer 132 to heat up above its melting point. This effect may create interlayer bonding between adjacent layers (e.g., 132 and 136) of portions of the 3D object 134.

Once the required layers of the 3D printed object are formed and the 3D printed object is built, the 3D printed object is subjected to thermal treatment (not shown). Thermal treatment is discussed above and comprises thermally treating the 3D printed object to a temperature of about 70° C. Thermal treatment is carried out to promote migration of the radiation-absorbing dye throughout the 3D printed object. For example, in some instances, prior to thermal treatment, there may be areas within the structure of the 3D printed object where the concentration of radiation-absorbing dye is higher than in other areas. This spatial variation in radiation-absorbing dye concentration may arise because of the sequence of build material and fusing agent deposition during the layer-by-layer build process. Accordingly, in some examples, the 3D printed object may have alternating dye-rich and dye-poor layers. These layers can alternate in the direction of build. Thermal treatment can promote migration of the soluble radiation-absorbing dye to improve the isotropy of the 3D printed object structure. In some examples, the results of thermal treatment can be discernible by visual inspection e.g. if the radiation-absorbing dyes are visible and of a colour that is distinguishable from the build material. In such instances, without thermal treatment, regions comprising high concentrations of radiation-absorbing dye may be visible as discernible layers from a cross-section of the 3D printed object. With thermal treatment, however, the discrete layers may be less discernible to the naked eye and the structure may have a more homogeneous appearance.

Thermal treatment may be carried out by heating within the printer. For example, thermal treatment may be performed when the 3D printed object is still positioned on the fabrication bed 110. Thermal treatment may be performed using example heat sources include an electromagnetic radiation source, such as an IR or near-IR light source.

Alternatively, thermal treatment may be carried out as a post-treatment step once the 3D printed object has been removed from the fabrication bed 110. Thermal treatment may be carried out in an oven or other heat treatment chamber.

FIG. 1E illustrates an example 3D object 134 formed in the fabrication bed 110. Objects, parts of objects, and layers thereof may be a variety of sizes and shapes, and are not limited to that illustrated by FIG. 1.

As illustrated by FIG. 1E, as layers 132, 136, 138 are formed, the delivery piston 106 can be pushed closer to the opening of the supply bed 102, and the supply of the build material 104 in the supply bed 102 is diminished (compared to FIG. 1A). The fabrication piston 114 can be pushed further away from the opening of the fabrication bed 110 for the subsequent layer(s) of build material 104 and the fusing agent 118. At least some of the build material 104 may remain unfused after each layer 132, 136, 138 is formed, and the 3D object 134 may be partially surrounded by the unfused build material. When the 3D object 134 is complete, it may be removed from the fabrication bed 110, and the unfused build material in the fabrication bed 110 may be reused depending on process conditions.

### Definitions

It is to be understood that aspects are not limited to the particular process and materials disclosed herein as such may vary to some degree.

It is also to be understood that the terminology used herein is used for the purpose of describing particular embodiments only and is not intended to be limiting, as the scope of the present method and other aspects will be defined only by the appended claims and equivalents thereof.

In the present specification, and in the appended claims, the following terminology will be used: context clearly dictates otherwise. Thus, for example, reference to “a co-solvent” includes reference to one or more of such co-solvents, unless otherwise stated. The singular forms “a”, “an” and “the” include plural referents unless the context indicates otherwise.

The terms “about” and “approximately” when referring to a numerical value or range is intended to encompass the values resulting from experimental error that can occur when taking and/or making measurements.

Concentrations, amounts, and other numerical data may be presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of approximately 1 wt. % to approximately 20 wt. % should be interpreted to include not only the explicitly recited concentration limits of 1 wt. % to approximately 20 wt. %, but also to include individual concentrations such as 2 wt. %, 3 wt. %, 4 wt. %, and sub-ranges such as 5 wt. % to 10 wt. %, 10 wt. % to 20 wt. %, etc.

Where reference is made to “anisotropy” and “isotropy”, these terms are relative terms and the properties of the 3D printed object may not be isotropic in an absolute sense. When radiation absorber e.g. carbon black is deposited onto a layer of build material, the radiation absorber may be localized at or near its site of application. In some examples, the radiation absorber may be localized at the interface between two layers of fused build material. This may have a detrimental effect on the bond between the layers of fused build material, such that mechanical properties e.g. elongation at break, in the build direction may be different from the mechanical properties perpendicular to the build direction. When a radiation-absorbing dye is used as the radiation absorber and thermal treatment is performed, the radiation-absorbing dye can migrate through the structure. This can improve the distribution of radiation-absorbing dye in the structure. In some examples, this can reduce e.g. the extent to which bonding between layers may be compromised. In some examples, isotropy can be improved. Accordingly, after thermal treatment, the difference in at least one mechanical property (e.g. elongation at break) in the build and perpendicular to the direction of build may be reduced compared to the same difference prior to thermal treatment.

### EXAMPLES

### Example 1—Fusing Agent Compositions

Example fusing agents were prepared having the compositions shown in Tables 1 and 2. The dye(s) were dissolved in the aqueous carrier of the fusing agent compositions.

TABLE 1

| Component | wt % |
|---|---|
| Hydroxyethyl-2- | 50 |
| pyrrolidone (HE2P) | |
| Benzyl alcohol | 16 |
| Dye 1 (AY-23) | 0.75 |
| Dye 2 (C854) | 2.5 |
| Surfactant (Tergitol | 0.8 |
| 15-S-9) | |
| DI Water | balance |

TABLE 2

| Component | wt % |
|---|---|
| Propylene glycol | 40 |
| Benzyl alcohol | 15 |
| Dye 1 (AY-23) | 1 |
| Urea | 15 |
| Surfactant (Sodium | 0.1-1 |
| Docusate) | |
| DI Water | balance |

### Example 2—Microtome Cross-Section Images

The example fusing agent Table 1 was used in an example 3D printing process to print 3D printed objects (dog bone test specimens) using thermoplastic polyamide as build material. Some of the 3D printed objects were thermally treated at 150° C. for 2 hours. Images of microtome cross-sections of the thermally treated 3D printed objects were compared to images of microtome cross-sections of the untreated 3D printed objects. These images are shown in FIG. 2 (see bottom two images in FIG. 2). In the untreated 3D printed objects (bottom left image in FIG. 2), the radiation-absorbing dye is concentrated in discrete regions within the structure. These discrete regions arise because of the manner in which the radiation-absorbing dye is deposited during the printing process. These discrete regions are visible as layers within the structure. With thermal treatment, these discrete regions are no longer visible (see bottom right image in FIG. 2). The radiation-absorbing dye is more uniformly dispersed throughout the 3D printed object's structure. This leads to improved isotropy.

### Comparative Example A—Comparative Microtome Cross-Section Images

As a comparison, a fusing agent containing carbon black (insoluble pigment) as a radiation absorber was used to print 3D printed objects (dog bone test specimens) using polyamide copolymer as build material. Some of the 3D printed objects were thermally treated at 150° C. for 2 hours. Images of microtome cross-sections of the thermally treated 3D printed objects were compared to images of microtome cross-sections of the untreated 3D printed objects. These images are also shown in FIG. 2 (see top two images in FIG. 2). In the untreated 3D printed objects (top left image in FIG. 2), the carbon black is concentrated in discrete regions within the structure. These discrete regions arise because of the manner in which the carbon black is deposited during the printing process. These discrete regions are visible as layers within the structure. With thermal treatment, the discrete layers remain as discernible throughout the structure (see top right image in FIG. 2). The structure is therefore more anisotropic because of the way carbon black is localized within the 3D printed object's structure.

### Example 3—Elongation at Break Measurements

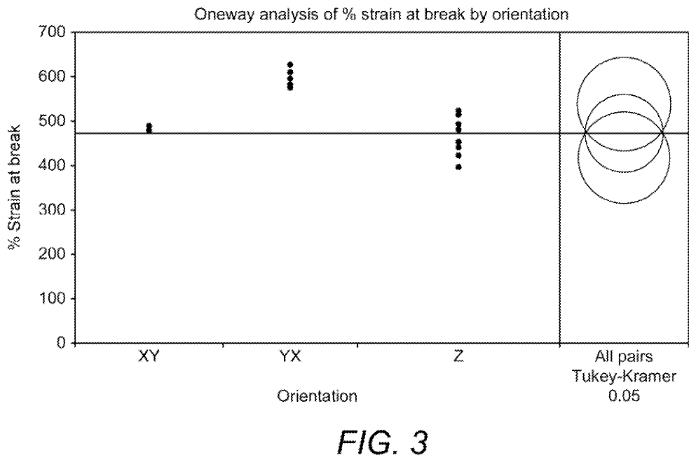

The elongation at break of a thermally treated dog bone specimen of Example 2 was measured in the build direction (z), and in directions perpendicular to the build direction (xy) and (yx). The strain at break, %, in each of the xy, yx and z orientations was plotted in FIG. 3. Tukey-Kramer analysis across different print orientations of specimens shows a statistically insignificant difference between elongation at break results. This suggests that mechanical properties are more isotropic or less dependent on build direction/orientation.

1. A method of printing a 3D printed object, said method comprising:
selectively applying a fusing agent onto a portion of a build material, wherein the fusing agent comprises a radiation-absorbing dye dissolved in an aqueous liquid carrier;
exposing the selectively applied fusing agent to radiation to produce heat energy to fuse the portion of build material to form a layer of the 3D printed object; and
thermally treating the 3D printed object at a temperature of above 70° C.

2. The method of claim 1, wherein, prior to thermal treatment, the 3D printed object comprises a first region and a second region, wherein the concentration of radiation-absorbing dye in the first region is higher than the concentration of radiation-absorbing dye in the second region, and
wherein, during thermal treatment, migration of radiation-absorbing dye occurs between the first region and the second region to decrease the difference in concentration in radiation-absorbing dye between the first region and the second region.

3. The method of claim 2, wherein, prior to thermal treatment, there is an alternating concentration of radiation-absorbing dye within the structure of the 3D printed object, whereby first regions of high concentration of radiation-absorbing dye alternate with second regions of low concentration of radiation-absorbing dye.

4. The method of claim 1, wherein the 3D printed object is thermally treated at a temperature that is within 100 degrees C. below the melting temperature of the build material.

5. The method of claim 1, wherein the build material comprises a polymer having a melting temperature of above 140° C.

6. The method of claim 1, wherein the fusing agent comprises less than 1 weight % of a radiation-absorbing pigment.

7. The method of claim 1, wherein the aqueous liquid carrier comprises water and an organic solvent.

8. The method of claim 7, wherein the organic solvent comprises a first organic solvent and a second organic solvent.

9. The method of claim 8, wherein the first organic solvent is a plasticizer.

10. The method of claim 8, wherein the second organic solvent is a solubilizer for solubilizing the radiation-absorbing dye and/or the first organic solvent in the liquid aqueous carrier.

11. The method of claim 7, wherein the first organic solvent is selected from benzyl alcohol and diethylene glycol butyl ether (DEGBE), and the second organic solvent is selected from diethylene glycol butyl ether (DEGBE), 1,2-hexanediol, hydroxyethyl-2-pyrrolidone (HE2P), glycerol, propylene glycol, ethylene glycol and 1,5-pentane diol.

12. The method as claimed in claim 7, wherein the weight ratio of the first organic solvent to the second organic solvent is 1:8 to 1:1.

13. The method of claim 1, wherein the radiation-absorbing dye absorbs radiation in the infrared or visible region of the electromagnetic spectrum.

14. The method of claim 1, wherein, after thermal treatment, the elongation at break perpendicular to the layers of the 3D printed object is at least 60% of the elongation at break along the layers of the 3D printed object.

15. A 3D printed object obtainable by the method of claim 1.
